(19) United States
(12) Patent Application Publication
(10) Pub. No.: US 2008/0298214 A1
(43) Pub. Date: Dec. 4, 2008

(54) Objective lens actuator utilizing piezoelectric elements

(75) Inventors: Masaru Uno, Hong Kong (CN); Makoto Takahashi, Hong Kong (CN)

Correspondence Address: NIXON & VANDERHYE, PC, 901 NORTH GLEBE ROAD, 11TH FLOOR, ARLINGTON, VA, 22203, US

(73) Assignee: SAE Magnetics (H.K) Ltd., Hong kong (CN)

(21) Appl. No.: 12/153,535

(22) Filed: May 20, 2008

(30) Foreign Application Priority Data
May 22, 2007 (JP) 2007-135063

(51) Int. Cl. G11B 7/00

(52) U.S. Cl. 369/112.23

(57) ABSTRACT

An objective lens actuator includes a lens holder for holding an objective lens, a holder support member for holding the lens holder movably along a direction of an optical axis of the objective lens and rotatably about a rotation axis that is parallel to the direction of the optical axis, and a base for holding the holder support member. A gap is provided between the holder support member and the base, the gap extending around a junction which connects the holder support member with the base, wherein a plurality of piezoelectric elements are inserted in the gap.

The present application is based on, and claims priority from, J.P. Application No. 2007-135063, filed on May 22, 2007, the disclosure of which is hereby incorporated by reference herein in its entirety.

### BACKGROUND OF THE INVENTION

1. Field of the Invention

The present invention relates to an objective lens actuator, an optical head and an optical disk drive, and in particular, relates to a tilt control mechanism for an objective lens actuator.

2. Description of the Related Art

In recent years, optical heads for high density recording and reproduction that utilize a blue laser light having a wavelength of about 405 nanometers have been known. There are two formats in this type of recording/reproduction system, and each format requires a specific recording medium. Thus, optical heads of a universal type that is applicable to both formats have been developed. The optical head of a universal type usually has a common optical system in order to share a light path, instead of separate optical systems that correspond to both recording mediums, respectively. The configuration having a common light path enables shared optical components, such as a beam splitter. However, an objective lens, which is provided adjacent to a recording medium and which functions to make a laser light focus on a predetermined position of the recording medium at a predetermined focal depth, has a specific numerical number (NA) for each recording format. Therefore, an optical head may have separate objective lenses for each recording format. Specifically, an objective lens for a High-Density Digital Versatile Disc (HD-DVD) requires a numerical number (NA) of 0.65, while an objective lens for the so-called “Blu-ray” (Registered Trade Mark), which also uses the same blue laser light for recording and reproduction, requires a larger NA of 0.85. Further, in order to perform recording and reproduction of a Compact Disc (CD) and a Digital Versatile Disc (DVD) by using a single optical head, the optical head requires wider NA coverage because an objective lens for the CD requires a NA of 0.45 and an objective lens for the DVD requires a NA of 0.60. However, it is impossible for a single objective lens to cover the entire NA range that is required. For this reason, even an optical head having a shared optical system generally has two objective lenses, which are selectively used depending on the recording medium that is used.

The focal point (focusing spot) of a laser light that is generated by an objective lens may be shifted from a predetermined position in the direction of the optical axis or in the track width direction due to irregularity of a recording medium and eccentricity of a rotating recording medium. Thus, there is a need for correcting the shift. For this purpose, an optical head is provided with a focusing control mechanism for adjusting the focal point in the direction of the optical axis (focal depth), and a tracking control mechanism for adjusting the focal point in the track width direction is also provided. Further, when an optical head reproduces information, a laser light that is emitted from a laser light source is radiated on a recording medium via a beam splitter, and the reflected light travels back along the same light path to enter the beam splitter. The laser light that has passed through the beam splitter is detected by an optical detecting means in order to read information recorded on the recording medium. Accordingly, if the light path of a laser light tilts relative to the normal line of a recording medium, then the incident light and the reflected light travel along different light paths. This impedes accurate reproduction of information. Thus, there is a need for a mechanism for achieving a light path of laser light or a light path of an optical axis of an objective lens that is kept perpendicular to a recording medium. This mechanism is called a “tilt control mechanism”.

An objective lens is held by a lens holder, which is supported by a holder support. The objective lens is supported by the lens holder along an edge of an opening provided at the lens attachment portion of the lens holder. Recently, a system called “a slidable and rotatable shaft type” has been known, in which the lens holder has a shaft hole formed therein and in which the lens holder is guided by a shaft that is fixed to the holder support by being inserted into the shaft hole. Conventionally, it has been difficult for the slidable and rotatable shaft type to perform tilt control, but recently, an optical head of this type that is capable of performing tilt control has also been developed (Japanese Patent Laid-Open Publication No. 2003-115121). According to this art, a lens holder has piezoelectric elements and projections, both of which are provided on an outer circumferential edge of the lens attachment portion. An objective lens is supported by the lens holder by the lens being fitted into the lens attachment portion such that it abuts the piezoelectric elements and the projections, and further by the lens being pressed by an elastic member from the opposite side. The piezoelectric elements are deformed in the direction of the optical axis of the objective lens, so that the objective lens pivots about the projections in order to perform tilt control. In addition, the lens holder is provided with coils, and the holder support has magnets that are provided opposite to the coils. Energization of the coil causes a magnetic interaction between the coil and the magnet (the Lorentz force), which moves the lens holder in the direction of the optical axis of the objective lens, as well as in the track width direction of a recording medium. This function enables focusing control and tracking control. The component that includes the lens holder and the holder support and that is adapted to movably support the objective lens is called an “objective lens actuator”.

The tilt control mechanism disclosed in Japanese Patent Laid-Open Publication No. 2003-115121 has a system in which the lens holder for holding the objective lens directly causes the objective lens to tilt. However, since the objective lens is provided adjacent to the recording medium, even a small amount of tilt may cause a large shift of the focal point, and in the worst case, may cause complete loss of the function of the servo mechanism. Further, the arrangement in which the piezoelectric elements are in direct contact with the objective lens causes large vibration of the objective lens itself. The objective lens is always subjected to vibration because of focusing control and tracking control. Therefore, if the objective lens is further subjected to vibration from the piezoelectric element, then the function to hold the objective lens can not be maintained by the pressing force of the elastic member alone, leading to degradation of performance and a reduction in reliability. Further, the lens holder and the holder support remain in a state in which they are tilted relative to the recording medium, although the optical axis of the objective lens is kept perpendicular to the recording medium. The coils and the magnets, which perform focusing control and tracking control, also remain in a state in which they are tilted relative to the recording medium because they are supported by the lens holder and the holder support, respectively. This also makes it difficult to perform focusing control and tracking control with high accuracy.

### SUMMARY OF THE INVENTION

An object of the present invention is to provide an objective lens actuator of the slidable and rotatable shaft type that is capable of performing focusing control, tracking control and tilt control with high accuracy. Another object of the present invention is to provide an optical head and an optical disk drive using the same.

An objective lens actuator according to an embodiment of the present invention comprises a lens holder for holding an objective lens, a holder support member for holding the lens holder movably along a direction of an optical axis of the objective lens and rotatably about a rotation axis that is parallel to the direction of the optical axis, and a base for holding the holder support member. A gap is provided between the holder support member and the base, the gap extending around a junction which connects the holder support member with the base, wherein a plurality of piezoelectric elements are inserted in the gap.

In the objective lens actuator having such a configuration, tilt control is performed by the piezoelectric elements that are provided in the gap that extends around the junction that connects the holder support member with the base. Deformation of the piezoelectric elements causes the holder support member to pivot about the junction, and thereby changes the tilt angle of the lens holder, which is supported by the holder support member, relative to a recording medium. The change in the tilt angle of the lens holder, which is caused by the deformation of the piezoelectric elements, depends on the amount of the deformation of the piezoelectric elements themselves and the distance between the piezoelectric elements. A larger distance between the piezoelectric elements leads to a smaller tilt angle of the lens holder if deformation of the piezoelectric elements is constant. This configuration enables a flexible arrangement of piezoelectric elements and ensures a sufficient distance between the piezoelectric elements. Accordingly, a rapid change in the tilt angle of the lens holder that may be cause by deformation of the piezoelectric elements can be effectively prevented.

According to another embodiment of the present invention, an optical head comprises said objective lens actuator and an objective lens that is mounted on said objective lens actuator.

According to yet another embodiment of the present invention, an optical disk drive comprises said optical head.

The above and other objects, features and advantages of the present invention will become apparent from the following description with reference to the accompanying drawings which illustrate examples of the present invention.

### BRIEF DESCRIPTION OF THE DRAWINGS

FIG. 1 is a block diagram schematically illustrating the configuration of an optical disk drive of the present embodiment;

FIG. 2 is a schematic diagram illustrating the optical arrangement of an optical head according to an embodiment of the present invention;

FIG. 3 is a plan view of an objective lens actuator;

FIG. 4 is a sectional view of the objective lens actuator cut along line 4-4 shown in FIG. 3;

FIG. 5 is a schematic perspective view for illustrating the magnetization pattern of the magnets and the configuration of the coils;

FIGS. 6A and 6B are sectional views, as seen from line 6-6 in FIG. 4;

FIGS. 7A to 7C are conceptual diagrams illustrating some variations of the piezoelectric elements and the elastic body; and

FIGS. 8A and 8B are conceptual diagrams illustrating another embodiment of the objective lens actuator.

### DETAILED DESCRIPTION OF THE INVENTION

Embodiments of an objective lens actuator, an optical head and an optical disk drive according to the present invention will be described with reference to the accompanying drawings.

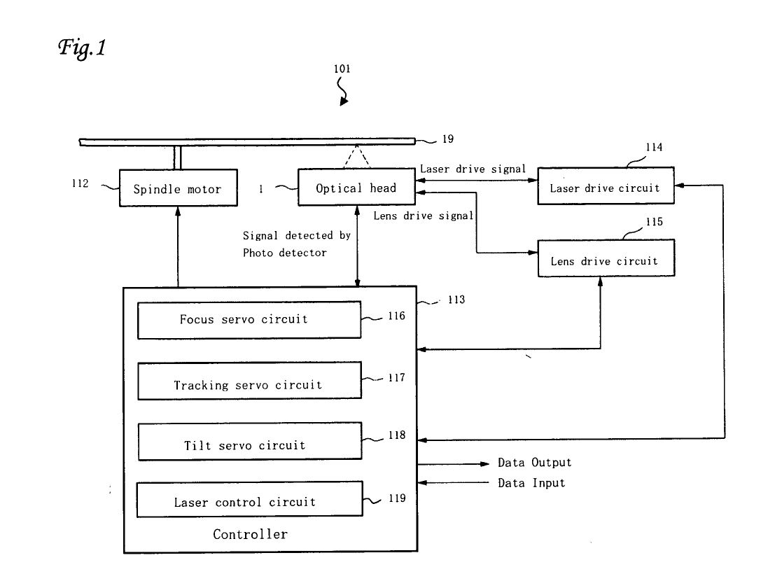

First, an optical disk drive of the present embodiment will be described. FIG. 1 is a block diagram schematically illustrating the configuration of an optical disk drive of the present embodiment.

Optical disk drive 101 includes optical head 1, spindle motor 112 for rotating recording medium 19, controller 113 for controlling spindle motor 112 and optical head 1, laser drive circuit 114 for supplying a laser drive signal to optical head 1, and lens drive circuit 115 for supplying a lens drive signal to optical head 1.

Controller 113 includes focus servo circuit 116, tracking servo circuit 117, tilt servo circuit 118 and laser control circuit 119. When focus servo circuit 116 operates, a laser light focuses on the surface of the rotating recording medium 19 on which information is recorded. When tracking servo circuit 117 operates, the spot of a laser light automatically tracks a signal track of recording medium 19 that may be eccentric. When tilt servo circuit 118 operates, tilt angles of objective lenses 14a, 14b, which will be described later, are automatically controlled so that the direction of the optical axis of objective lenses 14a, 14b corresponds to the direction of the normal line of recording medium 19. Focus servo circuit 116 includes the function of auto gain control for automatically adjusting the focus gain. Tracking servo circuit 117 includes the function of auto gain control for automatically adjusting the tracking gain. Tilt servo circuit 118 includes the function of auto gain control for automatically adjusting the tilt gain. A control signal generated by focus servo circuit 116, tracking servo circuit 117 and tilt servo circuit 118 is sent to lens drive circuit 115, which performs focusing control, tracking control and tilt control. Laser control circuit 119 generates a laser drive signal, which is supplied via laser drive circuit 114. Laser control circuit 119 generates a proper laser drive signal based on information about the recording condition recorded on recording medium 19. Focus servo circuit 116, tracking servo circuit 117, tilt servo circuit 118 and laser control circuit 119 are not limited to a built-in circuit in controller 113, and may be provided independent of controller 113. Alternatively, these circuits may be software that is used in place of a physical circuit and that is executed in controller 113.

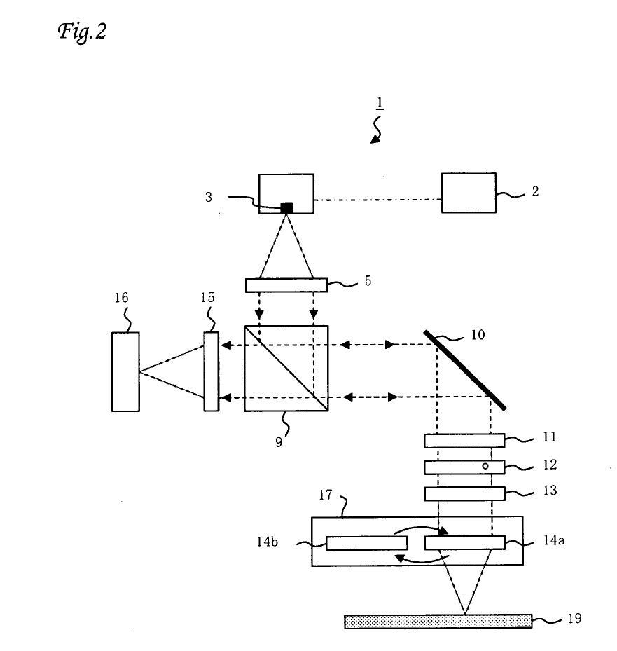

FIG. 2 is a schematic diagram illustrating the optical arrangement of an optical head according to an embodiment of the present invention. Optical head 1 includes laser oscillator 3 for emitting a laser light (a blue laser light) having a wavelength of 405 nanometers. Laser oscillator 3 may emit a laser light having a specific wavelength selected from 399 to 413 nanometers, including 405 nm, which is taken as an example. Laser oscillator 3 is connected to controller 2 that controls ON/OFF and the intensity of the laser light. Diffraction grating/half wave plate 5 is provided on the light path of the laser light that is emitted from laser oscillator 3. The diffraction grating is used for on-track control of the laser light. The half wave plate controls the direction of polarization of the laser light, and thereby controls reflection and transmission of the laser light within polarization beam splitter 9, which will be described later. These elements are integrated, but may be provided separately.

Polarization beam splitter 9 is provided next to diffraction grating/half wave plate 5. The laser light is refracted by polarization beam splitter 9, and enters reflecting mirror 10. The laser light that is reflected by reflecting mirror 10 travels through collimator lens 11, liquid crystal device 12 and quarter wave plate 13, and enters objective lens 14a that is held by objective lens actuator 17. Optical head 1 further includes objective lens 14b, and either one of the two objective lenses is selected depending on the type of the recording medium.

The laser light is converged at a predetermined depth within recording medium 19 by means of objective lens 14a or 14b, and recording/reproduction is performed. When recording is performed, recording medium 19 is irradiated with the laser light so that a phase change is caused in recording medium 19. When reproduction is performed, the laser light, after having been reflected, travels from objective lens 14 to polarization beam splitter 9 in the opposite direction. The reflected laser light has a property that corresponds to the contents recorded on recording medium 19. The reflected wave travels through polarization beam splitter 9, and, via sensor lens 15, enters photo detector 16 (light receiving element), which measures the intensity of light it receives. A measurement circuit, not shown, that is provided outside of optical head 1 detects the contents recorded on recording medium 19 based on the intensity of the light.

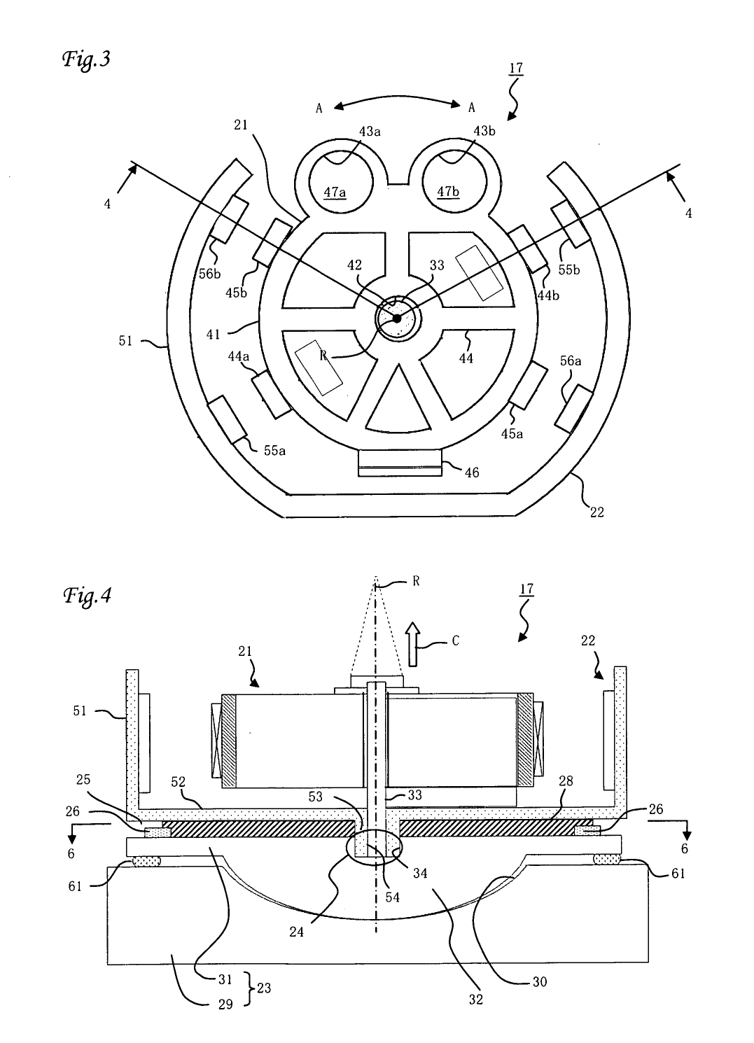

FIG. 3 is a plan view of the objective lens actuator. FIG. 4 is a sectional view of the objective lens actuator cut along line 4-4 shown in FIG. 3. Objective lens actuator 17 includes lens holder 21 for holding objective lenses 14a, 14b and holder support member 22, as well as base 23 for holding holder support member 22.

Lens holder 21 includes cylindrical member 41 that is reinforced by ribs 44, shaft hole 42 formed in cylindrical member 41 and objective lens attachment portions 43a, 43b for receiving objective lenses 14a, 14b, respectively. Objective lens attachment portions 43a, 43b include circular openings 47a, 47b, respectively. The outer circumstances of objective lenses 14a, 14b are configured to abut with the steps of openings 47a, 47b, not shown, that are formed along the peripheries of openings 47a, 47b. Objective lenses 14a, 14b are further clamped by a rubber cap, not shown, on the side opposite to the steps, so that objective lenses 14a, 14b are fixed to objective lens attachment portions 43a, 43b. Shaft 33 is inserted in shaft hole 42. Shaft 33 serves to guide lens holder 21 in direction C of the optical axis. Shaft 33 has a diameter that is smaller than the inner diameter of shaft hole 42 in order to enable smooth movement of lens holder 21 with respect to shaft 33.

Holder support member 22 has cylindrical member 51, bottom plate 52 and leg 53 that extends from bottom plate 52. Cylindrical member 51 is provided concentrically with cylindrical member 41 outside of cylindrical member 41 of lens holder 21. Holder support member 22 is fixed to adjustment spherical base 31, which will be described later, by leg 53 being inserted into recess 34 of adjustment spherical base 31. In other words, leg 53 and recess 34 form junction 24 that connects holder support member 22 with adjustment spherical base 31. Shaft 33 is fixed to holder support member 22 by being inserted in shaft hole 54 of leg 53.

Base 23 includes base plate 29 having semispherical depression 30. Base 23 also includes adjustment spherical base 31 having semispherical salient 32 on one surface thereof and having junction 24 on the other surface thereof. Adjustment spherical base 31 is fixed to base plate 29 by salient 32 being fitted with depression 30. In order to manufacture optical head 1, adjustment spherical base 31, shaft 33, holder support member 22 and lens holder 21 are integrally assembled first, and objective lenses 14a, 14b are then mounted. Subsequently, the direction of the optical axes of objective lenses 14a, 14b is adjusted by moving semispherical salient 32 within depression 30 of base plate 29. Thereafter, adjustment spherical base 31 is fixed to base plate 29 with adhesive 61. The adjustment of salient 32 can be performed, for example, by providing a plurality of adjustment screws, not shown, that penetrate base plate 29 and adjustment spherical base 31 and by rotating each adjustment screw. The configuration using adjustment spherical base 31 advantageously limits movement of objective lenses 14a, 14b in direction C of the optical axis and enables accurate adjustment of the optical axis.

Next, descriptions will be made about the mechanism for focusing control and tracking control of objective lens actuator 17. Drive coils 44a, 44b for focusing control are provided on the outer surface of cylindrical member 41 of lens holder 21 at positions opposite to each other, i.e., at an interval of 180 degrees. Further, drive coils 45a, 45b that are used for tracking control are provided on the outer surface of cylindrical member 41 of lens holder 21 at positions opposite to each other, i.e., at an interval of 180 degrees. The space between drive coil 44a and drive coil 45a is not limited to 90 degrees. Also, spacing between drive coil 44b and drive coil 45b is not limited to 90 degrees. Lead 46 for energizing coils 44a, 44b, 45a, 45b is also provided on the outer surface of cylindrical member 41 of lens holder 21. Magnets 55a, 55b for focusing control are provided on the inner surface of cylindrical member 51 of holder support member 22 at positions opposite to drive coils 44a, 44b, respectively. Similarly, magnets 56a, 56b for tracking control are provided on the inner surface of cylindrical member 51 of holder support member 22 at positions opposite to drive coils 45a, 45b, respectively.

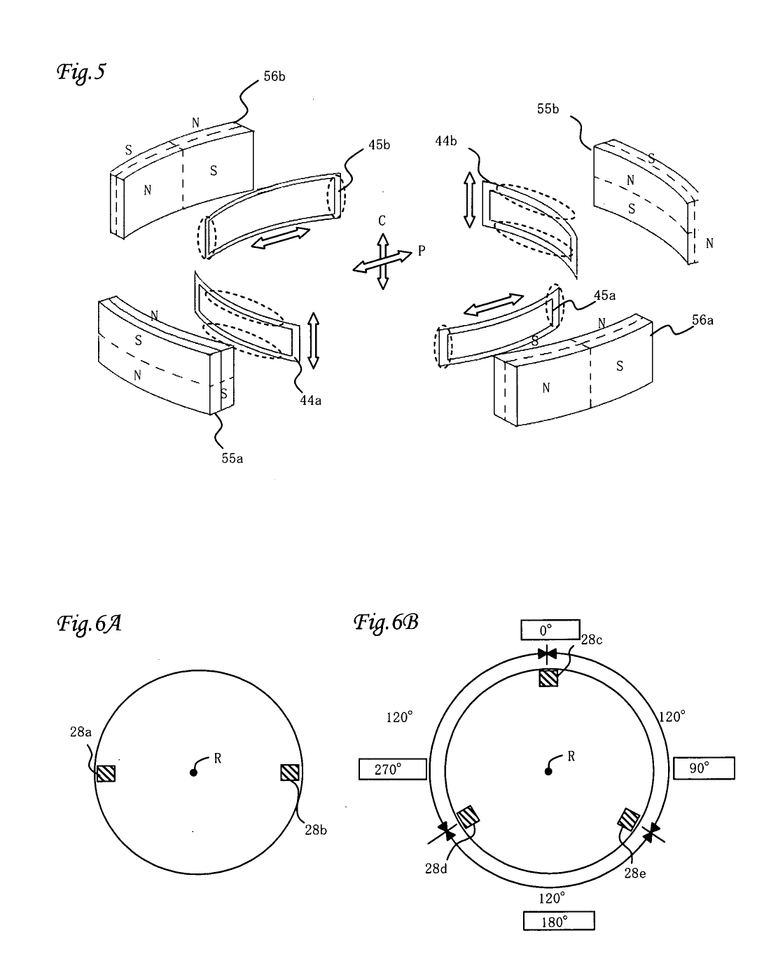

FIG. 5 is a schematic perspective view illustrating the magnetization pattern of the magnets and the configuration of the coils. Each of coils 44a, 44b, 45a, 45b has a rectangular shape, but may have any other shapes, such as a circular shape, an elliptical shape or a polygonal shape. On the side of magnets 55a, 55b that is opposite to drive coils 44a, 44b for focusing control, the N-pole and the S-pole are directed to the top and the bottom of the figure, respectively, being aligned with direction C of the optical axis. Accordingly, magnetic fields mainly act on the upper hems and the lower hems of drive coils 44a, 44b, shown by the dashed lines, which thereby function as effective parts of the coil. Energization of drive coils 44a, 44b for focusing control causes a magnetic interaction (the Lorentz force) between the magnetic fields that are generated by magnets 55a, 55b and the electric current that flows in drive coils 44a, 44b. Because of this force, drive coils 44a, 44b for focusing control are subjected to an upward force or a downward force in direction C of the optical axis depending on the direction of the current, and thereby lens holder 21 can be moved in direction C of the optical axis.

On the side of magnets 56a, 56b that are opposite to drive coils 45a, 45b, the N-pole and the S-pole are directed to the left and the right of the figure, respectively, being aligned with a direction that is perpendicular to direction C of the optical axis. Accordingly, magnetic fields mainly act on the right hems and the left hems of drive coils 45a, 45b that are used for tracking control, shown by the dashed lines, which thereby function as effective parts of the coil. Energization of drive coils 45a, 45b that are used for tracking control causes a magnetic interaction (the Lorentz force) between the magnetic fields that are generated by magnets 56a, 56b and the electric current that flows in drive coils 45a, 45b. Because of this force, drive coils 45a, 45b that are used for tracking control are subjected to a rightward force or a leftward force in direction P depending on the direction of the current, and thereby lens holder 21 can be rotated about rotation axis R, as shown in FIG. 3. As a result, objective lenses 14a, 14b, which are mounted apart from central axis R, are rotated in the left-right direction in FIG. 3, i.e., in direction A-A. By mounting optical head 1 with respect to a recording medium such that the left-right direction in FIG. 3 corresponds to the track width direction of the recording medium, objective lenses 14a, 14b can be moved in the track width direction.

In this way, lens holder 21 is held by holder support member 22, movably along direction C of the optical axis of objective lenses 14a, 14b and rotatably about rotation axis R that is parallel to direction C of the optical axis. In addition, objective lenses 14a or 14b can also be selected by rotating lens holder 21.

Gap 25 is provided between bottom plate 52 of holder support member 22 and adjustment spherical base 31 of base 23. Gap 25 extends around junction 24 that connects holder support member 22 with base 23. Accordingly, holder support member 22 is not directly connected to base 23 in the vicinity of junction 24. A plurality of piezoelectric elements 26 are inserted in gap 25. FIGS. 6A and 6B are sectional views, as seen from line 6-6 in FIG. 4. In FIGS. 6A and 6B, the elastic body, which will be described later, is omitted. In one embodiment that is shown in FIG. 6A, two piezoelectric elements 26a, 26b are provided at positions opposite to each other. This embodiment only enables tilt control in the plane that includes two piezoelectric elements 26a, 26b. In the present embodiment that is shown in FIG. 6B, piezoelectric elements 26c, 26d, and 26e are provided equidistant from central axis R at an angular interval of 120 degrees. By separately adjusting deformation of each piezoelectric element 26c, 26d, and 26e in direction C of the optical axis, tilt control can be performed in any desired plane that includes direction C of the optical axis. For example, a tilt movement about the axis that connects 0 degrees and 180 degrees in FIG. 6B can be achieved by deforming piezoelectric elements 26d and 26e by the same amount but in the directions opposite to each other with respect to direction C of the optical axis, respectively, without deforming piezoelectric element 26c. Also, a tilt movement about the axis that connects 90 degrees and 270 degrees in FIG. 6B can be achieved by deforming piezoelectric element 26c in one direction with respect to direction C of the optical axis, and by deforming piezoelectric elements 26d and 26e by half the amount of the deformation of piezoelectric element 26c in the opposite direction with respect to direction C of the optical axis. The present embodiment having three piezoelectric elements is advantageous because direction C of the optical axis can tilt in any direction with respect to the recording medium.

The configuration having three piezoelectric elements is advantageous in other respects. Conventionally, an adjustment of the direction of the optical axis of an objective lens requires a fine adjustment process of the direction of the optical axis that involves an operator's confirmation of the quality of the laser spot of the objective lens at the focal point or confirmation of the reproduced electrical signals of the recording medium. The configuration having three piezoelectric elements, which enables tilt control in any desired directions, does not require such a fine adjustment of the direction of the optical axis during manufacturing. Specifically, the direction of the optical axis, which is automatically adjusted, only requires rough adjustment during manufacturing, and can even eliminates the needs for an adjustment process, depending on the conditions. This provides advantages, such as a reduction in adjustment time and unmanned operation.

Referring to FIG. 4, elastic body 28 that is made of rubber is inserted in gap 25. Elastic body 28 prevents external vibration from being transferred to objective lens actuator 17. External vibration that acts on objective lens actuator 17 may adversely affect focusing control and tracking control. The external vibration may also vibrate objective lenses 14a, 14b, and may cause degradation of performance and a reduction in reliability of the objective lenses. In the present embodiment, piezoelectric elements 26c, 26d and 26e are mounted on adjustment spherical base 31, and are connected to bottom plate 52 of holder support member 22 via elastic body 28. In the regions in which piezoelectric elements 26c, 26d and 26e are not provided, elastic body 28 is in contact with both bottom plate 52 and adjustment spherical base 31.

The elastic body may be a spring. However, rubber is more preferable because of the large damping effect in a wider frequency range. In particular, the vibration mode of the rubber is inverted by 180 degrees relative to the external vibration in the frequency range that is higher than the resonance frequency of the rubber. This causes an increase in the relative velocity between the rubber and the external vibration. Since the degree of energy damping caused by viscoelasticity of the rubber is proportional to the relative velocity, larger effect of vibration damping can be obtained for vibration frequencies that are higher than the resonance frequency of the rubber. When a spring is used, the spring should be designed taking into account the resonance frequency of objective lens actuator 17. However, a large vibration damping effect can not be expected except for the resonance frequency.

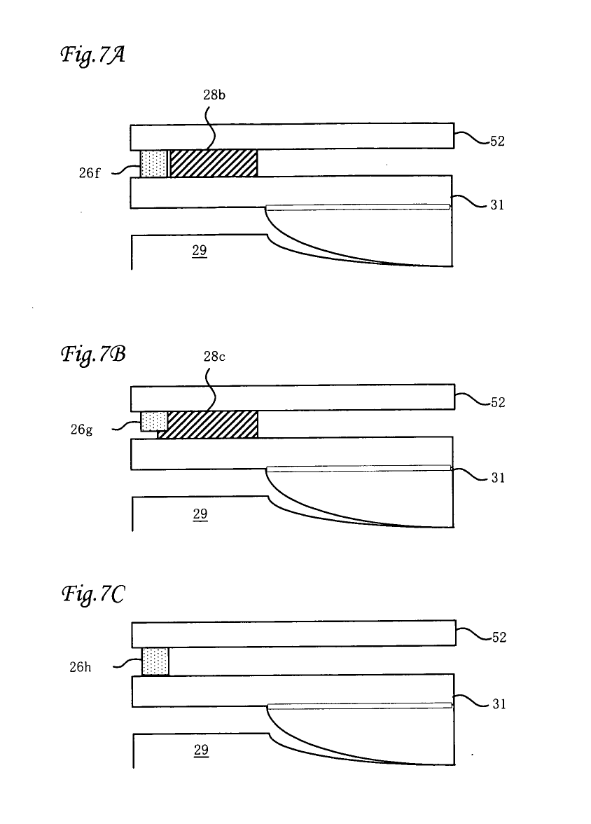

Although certain embodiments of the optical head and the objective lens actuator have been described, it can be easily understood that the invention is not limited to the embodiments described above. For example, the configuration of the piezoelectric elements and the elastic body is not limited to the present embodiment. Any configurations are possible as long as tilt control and vibration damping are achieved. FIGS. 7A to 7C are conceptual diagrams illustrating some variations of the piezoelectric elements and the elastic body. Referring to FIG. 7A, both piezoelectric element 26f (the other piezoelectric elements are not shown in FIGS. 7A to 7C) and elastic body 28b are in contact with both bottom plate 52 and adjustment spherical base 31. Referring to FIG. 7B, piezoelectric element 26g is mounted to bottom plate 52 of holder support member 22 and is connected to adjustment spherical base 31 via elastic body 28c. The configuration shown in FIG. 7C only has piezoelectric element 26h. The piezoelectric element has its inherent capacity for vibration damping. Thus, the elastic body may be omitted if external vibration is limited or if external vibration is prevented by other means. The configuration shown in FIG. 7C only uses the piezoelectric elements in order to perform tilt control and vibration damping, and advantageously, provides a reduction in the number of components.

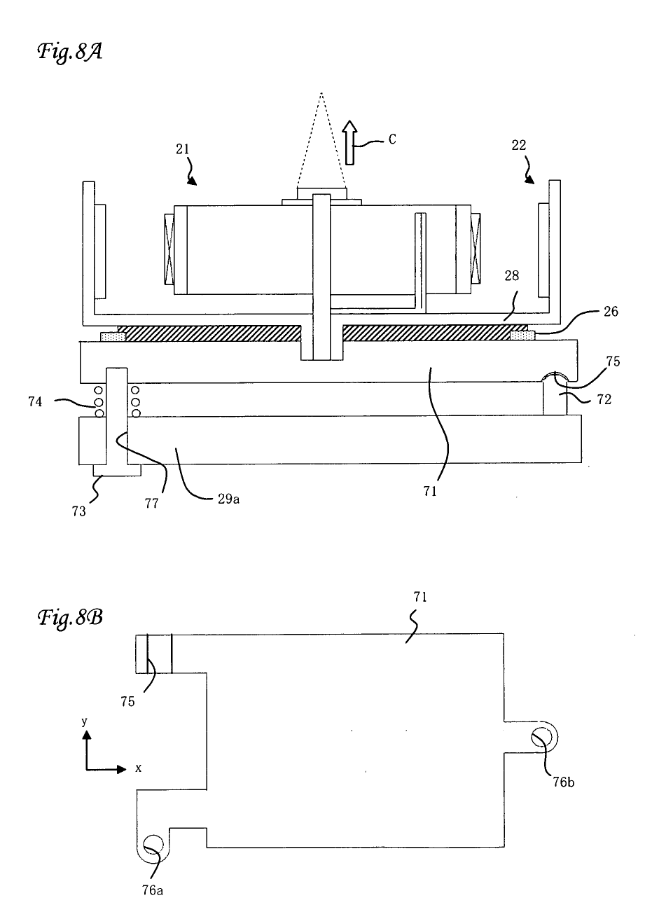

Alternatively, a pivot-type mechanism for adjusting the optical axis may be used in order to adjust the optical axis, instead of the adjustment spherical base that is described in the above embodiment. FIGS. 8A and 8B are a sectional view illustrating another embodiment of the objective lens actuator, and a bottom view of an adjustment base, respectively. In this embodiment, adjustment base 71 is used instead of the adjustment spherical base. Base plate 29a has projection 72 that extends therefrom, and the end of projection 72 fits in salient 75 that is formed on the bottom surface of adjustment base 71. Screw 73 passes through opening 77 that is provided within base plate 29a, and engages with threaded opening 76a of adjustment base 71. Another screw, not shown, also passes through an opening, not shown, that is provided within base plate 29a, and engages with threaded opening 76b of adjustment base 71. Spring 74 is provided between adjustment base 71 and base plate 29a. By adjusting two screws, adjustment base 71 pivots about projection 72 along the X and Y axes in FIG. 8B.

Although two objective lenses are employed in the embodiments described, the number of the objective lenses is not limited to two. The optical head may have a single objective lens, or may have an additional objective lens for a CD or a DVD. The piezoelectric elements do not have to be located equidistant from the rotation axis. Also, four or more piezoelectric elements may be provided.

Although certain preferred embodiments of the present invention have been shown and described in detail, it should be understood that various changes and modifications may be made without departing from the spirit or scope of the appended claims.

What is claimed is:

1. An objective lens actuator comprising:
a lens holder for holding an objective lens,
a holder support member for holding the lens holder movably along a direction of an optical axis of the objective lens and rotatably about a rotation axis that is parallel to the direction of the optical axis, and
a base for holding the holder support member, wherein
a gap is provided between the holder support member and the base, the gap extending around a junction which connects the holder support member with the base, wherein a plurality of piezoelectric elements are inserted in the gap.

2. The objective lens actuator according to claim 1, wherein an elastic body is inserted in the gap.

3. The objective lens actuator according to claim 2, wherein the elastic body is made of rubber.

4. The objective lens actuator according to claim 1, wherein the number of the piezoelectric elements is three.

5. The objective lens actuator according to claim 1, wherein
the base comprises a base plate that includes a semispherical depression and an adjustment spherical base that has a semispherical salient on one surface thereof and that has said junction on the other surface thereof, wherein the salient is fitted in the depression so that the adjustment spherical base is fixed to the base plate.

6. An optical head comprising:
the objective lens actuator according to claim 1, and
an objective lens that is mounted on the objective lens actuator.

7. An optical disk drive comprising the optical head according to claim 6.
